(19) United States
(12) Patent Application Publication
(10) Pub. No.: US 2012/0023476 A1
(43) Pub. Date: Jan. 26, 2012

(54) Puzzle Driven Development (PDD) Method and Software

(75) Inventor: Yegor Bugayenko, Naples, FL (US)

(73) Assignee: Mr. Yegor Bugayenko, Naples, FL (US)

(21) Appl. No.: 12/840,306

(22) Filed: Jul. 21, 2010

(51) Int. Cl. G06F 9/44

(52) U.S. Cl. 717/103

(57) ABSTRACT

Puzzle Driven Development (PDD) method and software that optimizes communication and planning of concurrent development in a distributed software project by means of @todo tags (called “puzzles”) maintained in the source code by software engineers.

### BACKGROUND

1. Field of Invention

The present invention generally relates to automated project management in software development, specifically in distributed projects, but also in co-located projects.

2. Prior Art

Distributed software development is rapidly becoming the norm for technology companies [7]. The ability of a company to successfully carry out its tasks depends on the appropriate combination of organizational structure, processes, and collaborative tools [4]. Recent studies show that existing collaborative software tools are used mostly as “shared repositories”, while discussions take place outside of the tool in e-mails, chats or phone calls [11, 10].

Consider an example where a programmer was assigned to implement a new software function. He created a new separate version control “branch” [8, 13, 9], and was aware of “continuous integration” [6] principle advocated in the project. The implementation was planned to take a few days, but he faced a few problems and raised a number of questions during development. Once his questions were answered and the branch was ready for integration with the main stream, he realized that the main stream received a number of important changes. Synchronization of the branch with the main stream took some time, and produced new questions and problems. After a number of such synchronization iterations, the branch was considered as out-dated and was closed.

The example illustrates a “delayed branch” problem, which does not have a solution in existing software development methodologies [3, 1, 12]. There are a number of possible workarounds, including: a) breaking the principle of continuous integration and merging of a “broken” branch with the main stream; b) closing the branch after the first problem or question, in order to minimize time and cost losses; or c) pausing the branch and hoping for the best. None of these workarounds really solve the problem [2]. However, a solution is needed because its absence can effectively ruin the development of an enterprise project, especially if the team is remotely distributed [5].

### SUMMARY

The invented “Puzzle Driven Development (PDD) Method and Software” includes a specific method and software that resolves the problem of “delayed branches” conflict in concurrent distributed software development, and in many other types of software development projects.

Every time a developer is working with a branch and sees a problem or a question that needs the participation of another programmer, he implements a temporary solution that keeps the code compilable. He marks the place in the code with @todo tag (called “puzzle”) and merges the branch into trunk. The “puzzle” includes the identifier of a task he was working with. As long as the “puzzle” stays in source code, a project manager considers the task as incomplete and pending resolution. The project manager assigns “puzzle” resolution to other team members. When all “puzzles” are resolved, the project manager returns the task back to the programmer, asking him to continue with development.

The key advantage of the PDD method, comparing with all other known approaches, is the absence of long branches. Implementation of every task, no matter how difficult it is, takes a few hours in one iteration. Then the task is set to pending state and new “puzzles” are merged into trunk. Project planning becomes more predictable and simple, since the project manager is dealing with a large amount of small isolated tasks, instead of long and risky activities. With this method, cost and scope control also becomes more effective.

Properly used “puzzles” becomes the main management and communication mechanism in a distributed software project, replacing e-mails, online discussions and phone calls. Moreover, the PDD software collects “puzzles” from source code and builds short-term plans of key development tasks.

### SHORT DESCRIPTION OF DRAWINGS

FIG. 1 is the main sequence diagram explaining how project manager, programmer, and architect are interacting during implementation of a product feature in a PDD empowered project.

FIG. 2 is the sequence diagram with interaction between programmer, project manager, and architect in a project without PDD.

FIG. 3 visually shows the process of branching in a project with PDD, and compares it with a project without PDD.

FIG. 4 indicates dependencies between tasks in a PDD project.

FIG. 5 contains a sample Network Diagram of tasks produced in a sample project with PDD.

FIG. 6 includes a Gantt Chart with tasks defined in Network Diagram.

### DETAILED DESCRIPTION OF DRAWINGS

While this invention is susceptible to be embodied in many different forms, a specific embodiment is shown in the drawing and will be described herein in detail. The present disclosure is to be considered as an exemplification of the principles of the invention and is not intended to limit the invention to the specific embodiments illustrated.

To understand the PDD mechanism and software, consider a sample Java component with a few functions. Implementation of the component is done by two people. The first one is an architect, who leads the development of this area, and the second one is a programmer who is responsible for the component hands-on coding in Java. The result is achieved in three iterations. On the first iteration, the programmer makes initial changes to the code according to the task specified by the architect. The programmer is asked to implement a file converter, but he does not know where to get the file name to convert. The first version of the class contains “puzzles” embedded into the source code as @todo tags (lines 3-8 and 11-16 of the Java listing below):

```
class Convert {
  public void convert( ) {
    File f = getFile( );
    /**
    * @todo #123! This is just a stub
    * for now, I will fix it when other
    * puzzles are solved.
    */
    return fileToString(f);
  }
  /**
  * @todo #123 This method shall find
  * a file and return it as an object.
  * I don't know where to get implementation
  * details for this method.
  */
  protected File getFile( ) {
    return File(“/dev/null”);
  }
}
```

The class is compilable, testable, and immediately becomes a part of project trunk.

The programmer does not wait for an answer from the architect, but implements the component as he understands it, with the minimum information available. The only criteria of this first iteration completeness is the consistency of the implementation (it should not break the other project code).

Thus, the implementation is reviewed by the architect and merged into the main trunk of development. The functionality is not yet implemented in full, but it doesn't break the other project code and can be merged. The architect does not wait until the programmer implements everything in full and does not answer the questions in informal communication channels. Instead, the architect takes the code created by the programmer and merges it into trunk.

When it is done, the architect “resolves puzzles” raised by the programmer. He can do it himself or the programmer can assign a new task to another programmer capable of resolving them. The next commit to the trunk resolves the “puzzles” and removes them from the source code (lines 14-20):

```
import org.xml.sax.InputSource;
import javax.xml.xpath.*;
class Converter {
  public void convert( ) {
    File f = getFile( );
    /**
    * @todo #123! This is just a stub
    * for now, I will fix it when other
    * puzzles are solved.
    */
    return fileToString(f);
  }
  protected File getFile( ) {
    XPath xpath = XPathFactory.newInstance( ).newXPath( );
    return new File(
      xpath.evaluate(
        “/input/directory”,
        new InputSource(“config.xml”)
      ) + name + “.txt”
    );
  }
}
```

The architect did not touch the “puzzles” that have an exclamation mark after the number of the task (#123! in this example, lines 6-10). Such a mark means that the “puzzle” will be resolved by its author, once other “puzzles” are solved by someone else.

The task is returned to the first programmer, and he is asked to continue the development, since the “puzzles” are solved. The programmer has to finish the implementation of the original task and now he has all the information required:

```
import org.xml.sax.InputSource;
import javax.xml.xpath.*;
class Converter {
  public void convert( ) {
    File f = getFile( );
    return fileToString(f).toLowerCase( );
  }
  protected File getFile( ) {
    XPath xpath = XPathFactory.newInstance( ).newXPath( );
    return new File(
      xpath.evaluate(
        “/input/directory”,
        new InputSource(“config.xml”)
      ) + name + “.txt”
    );
  }
}
```

After the third iteration the implementation of the class is finished and the task is closed by the architect. The code is free of “puzzles”, but the source code version control repository contains the history of discussion between the architect and the programmer.

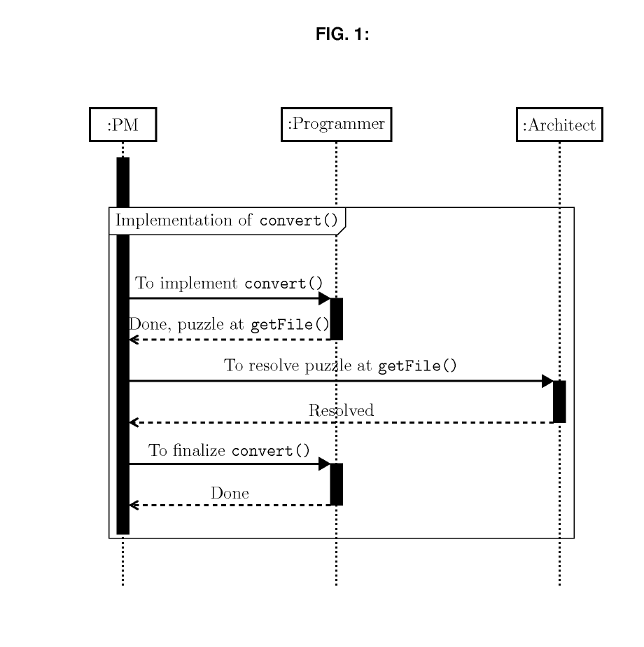

Sequence diagram on FIG. 1 explains the interaction between three people: project manager (PM), architect, and programmer. The PM controls the process and assigns tasks to implementers. The architect is responsible for the technical aspects of the code and is responsible for the stability of project trunk. The programmers are doing actual programming/coding and are responsible for software functionality.

The PM starts the task and assigns it to the programmer. The task is the same as in the example above—the programmer has to implement method convert ( ). The programmer starts a new “branch” in source code repository and commits his preliminary changes. The changes include @todo tags. This is an indicator for the PM that the task is not finished yet, but it is just a partial implementation. The changes do not break the code in trunk and are seamlessly merged into it.

The PM understands that the task is not completed in full, and he knows that there is one “puzzle” in the code that should be resolved before he can return this task back to the programmer for its final implementation. And, there is one puzzle that has to be resolved by the programmer himself. An optimistic forecast for this task says that when these two “puzzles” are solved, the task is finished. The PM decides to involve the architect, and assigns a new task to him. According to this task, the architect has to resolve the “puzzle” in the code. The architect accomplishes this in a new branch and this branch goes into trunk immediately.

The PM gets a better picture now—there is one “puzzle” left in the code and it has to be resolved by its author, the programmer. The PM assigns the task back to programmer and he implements the functionality in full, in a new branch. The branch immediately goes into the trunk. The PM closes the task as finished.

“Puzzles” may include additional information valuable for managers and engineers, for example (the list is not complete and may be extended for the needs of a particular project):

| “Puzzle” | Meaning of the puzzle for management and |
|---|---|
| formatting | engineering staff |
| #123: 2 hrs | The ticket #123 is waiting for a resolution of |
| | this “puzzle”, and an approximate amount of |
| | efforts required for this work is 2 hours |
| | (according to the estimate of the author of |
| | this “puzzle”). |
| #123: peter | The “puzzle” should be resolved by peter, |
| | one of project team programmers. |
| #123: CRITICAL | The priority of this “puzzle” is set to critical |
| | level, and it has to be resolved first. |

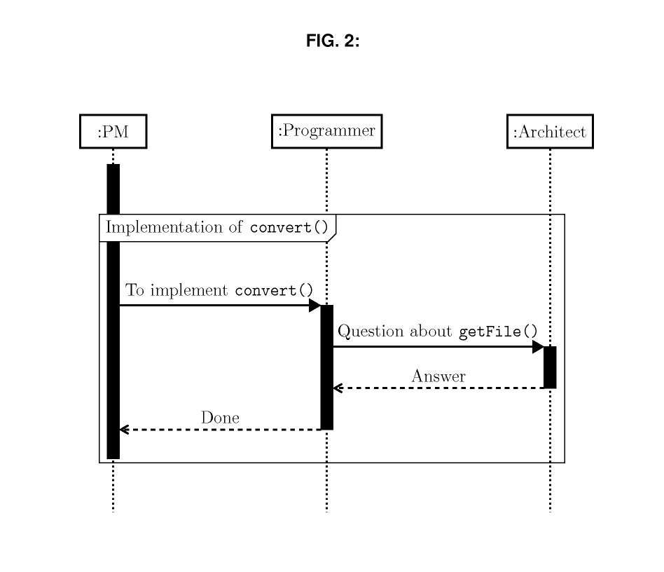

Sequence diagram in FIG. 2 shows how the same goal could be achieved without PDD approach. In this diagram, a “delayed branch” mechanism is used. The programmer does not commit his/her branch to the trunk while waiting for an answer from the architect. When the answer comes back, the programmer commits the branch and closes it.

When two diagrams (FIG. 1 and FIG. 2) are compared it becomes clear that the duration of the programmer's branch is much longer with a usual approach. Moreover, the duration of the branch does not depend on the programmer, but on many other factors in the project. Thus, there is a big chance that the branch might never reach trunk. This is mostly because the trunk might receive changes that will seriously contradict with the branch.

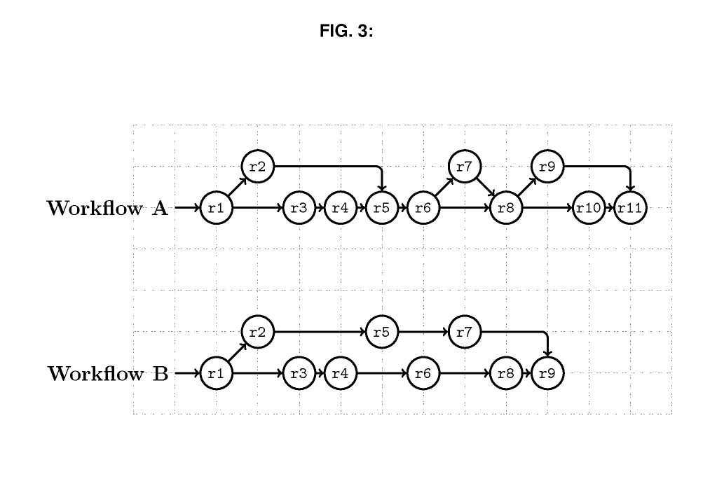

The diagram in FIG. 3 compares two approaches visually explaining source code repository changes and merges. Workflow A uses PDD concept and creates three branches during the development of the feature. Workflow B uses a “delayed branch” approach and creates just one branch during the development of the same feature. The picture clearly indicates that Workflow B has much higher risk of conflict during branch merging with the trunk.

Workflow B in details (the workflow is a simplified example of a real-life software project): The source code repository is in revision

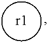

and the programmer receives a task from the project manager and starts a new branch in order to implement it. The programmer makes initial implementation and commits changes with

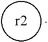

Suddenly, the programmer understands that he does not have enough information in order to complete the task, so he asks the project manager for help. The project manager decides that the architect should be helpful in this situation and forwards the request to him. Once the answer is ready, the programmer receives it (by e-mail). According to the information received, the programmer makes his next commit to the repository. While the programmer was waiting for the answer, the repository received two changes from other team members, in revisions

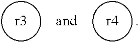

Thus, the programmer commits his changes in revision

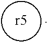

Now, the feature is almost finished and only one final change has to be done before returning it back to the trunk. The programmer makes that change and commits it to the repository, in revision

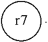

The project manager is notified about the finished feature and merges the branch into the trunk in

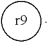

### Revisions

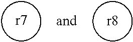

were committed to the repository by other project team members. The distance between merging the branch into the trunk and starting the branch is 7 revisions.

To the contrary, Workflow A looks differently: The repository is in revision

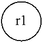

and the programmer makes her first changes in

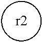

(similar to Workflow B). Now the programmer understands the necessity of additional information and refers to the project manager. The programmer makes the branch ready for merging into trunk by means of “stubs” and properly commented places, which are not implemented yet. The project manager merges the branch into trunk in revision

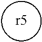

(the distance is 2 revisions and the risk of conflict is much lower than in Workflow B). The project manager decides who is going to resolve the question asked by the programmer, finds the right person, assigns this problem to him and waits for the answer. The answer comes in a new branch, revision

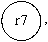

where the architect (author of the answer) makes comment right inside the source code. This branch immediately goes into trunk, in revision

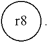

The project manager returns the task back to the programmer and asks him to finish the task, since all answers are received and embedded in the source code. The programmer starts a new branch and implements the code she could not implement before. The programmer makes changes in revision

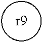

and the project manager merges them into trunk in

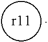

The longest distance is 2 revisions and the risk of conflict during merging is much smaller than in Workflow B.

It is obvious that a long-lasting branch (as in Workflow B) will cause higher risks of conflicts during merging into the trunk. With shorter branches, every programmer has more flexibility and freedom to make risky changes without a high risk of being rejected during merging.

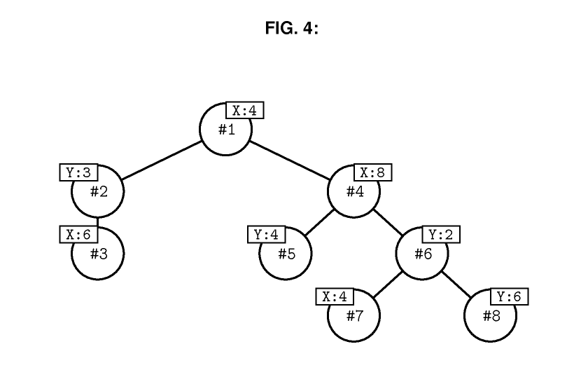

Diagram in FIG. 4 shows how task may be dependent on other tasks, producing “a tree” of tasks. In the diagram, the task #1 was not finished by its implementer and he returned the task back with two “puzzles” embedded in the code. These “puzzles” were assigned to the implementers in two new tasks: #1 and #4. The task #4 produced tasks #5 and #6, and so forth.

The task #1 will be finished only when tasks #2 and #4 are finished. Thus, the duration of the task #1 is the longest, and may take weeks or months. But the duration of the branch for task #1 is no longer than a few hours required to implement it. The same is true for all other tasks in the set.

Every task has its own time/effort estimate, and an implementer. For example, as shown in the diagram in FIG. 4, task #4 will be implemented by X (a mnemonic name of an implementer) and within 8 hours. When a programmer adds a new “puzzle” to the code he can add his estimate of time/effort required to implement this “puzzle”, for example:

```
class Convert {
  /**
  * @todo #123:2hrs Here we should load an XML
  * config file and construct a file name
  * from directory name
  */
  protected File getFile( ) {
    return File(“/dev/null”);
  }
}
```

This “puzzle” not only explains what is required to implement, but gives a preliminary estimate of time/effort such an implementation would require. By means of such “puzzles”, programmers help the project manager build a project plan and identify activities to be accomplished in the project.

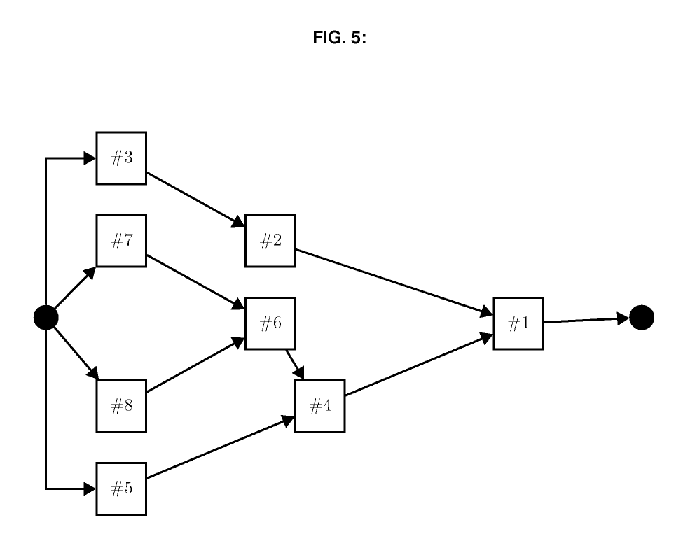

FIG. 5 contains an example of a Network Diagram that could be built using the information retrieved from “puzzles” on FIG. 4. The Network Diagram shows dependencies between tasks and helps to identify a critical path the shortest distance between start and finish of the entire work. The critical path contains tasks #8, #6, #4, and #1. The duration of the critical path is 20 hours.

It's important to notice that the only source of information for the Network Diagram is the source code and “puzzles” inside it. No prior planning was done in order to produce the diagram. The information is collected from programmers, architects, and other engineers directly from the source code written by them. Such a principle helps to avoid duplication of information and waives the necessity to re-synchronize project plans with the project team. The plans are inside the source code and are available for everybody who has access to the project repository.

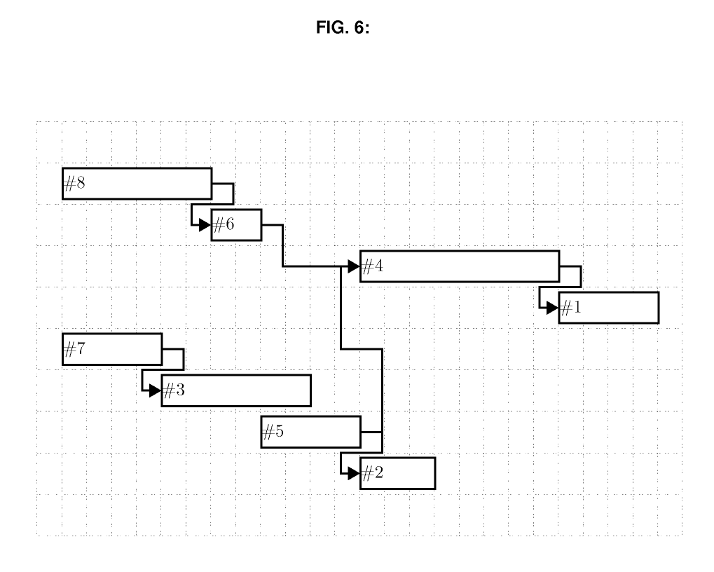

The Gantt Chart on FIG. 6 attaches the Network Diagram from FIG. 5 to the calendar. Tasks become assigned to implementers and key milestones become visible. This chart could be drawn in an automated manner by PDD software, and be made available to everybody inside the project team. Changes to the source code immediately affect the planning diagrams, including Gantt Chart and Network Diagram.

### U.S. PATENT DOCUMENTS

| | | |
|---|---|---|
| 7,533,364 | May 2009 | Ramaswamy et al. |
| 12/112,486 | November 2009 | Sharma |

### REFERENCES

[1] Rational unified process (rup). Technical Report 7.0, International Business Machines (IBM).
[2] Brad Appleton, Stephen P. Berczuk, Ralph Cabrera, and Robert Orenstein. Streamed lines: Branching patterns for parallel software development. http://www.cmcrossroads.com/bradapp/acme/branching/.
[3] Kent Beck. Extreme Programming Explained: Embrace Change. Addison-Wesley Professional, us ed edition, 1999.
[4] Marcelo Cataldo, Matthew Bass, James D. Herbsleb, and Len Bass. On coordination mechanisms in global software development. In ICGSE '07: Proceedings of the International Conference on Global Software Engineering, pages 71-80, Washington, D.C., USA, 2007. IEEE Computer Society.
[5] Martin Fowler. Featurebranch, simple (isolated) feature branch. http://martinfowler.com/bliki/FeatureBranch.html.
[6] Martin Fowler. Continuous integration, November 2009.
[7] J Herbsleb and A Mockus. An empirical study of speed and communication in globally distributed software development. IEEE Transactions on Software Engineering, 29(6):481-494, 2003.
[8] P Louridas. Version control. IEEE Software, 23(1):104-107, 2006.
[9] Michael Pilato, Ben Collins-Sussman, and Brian Fitzpatrick. Version Control with Subversion. O'Reilly Media, Inc., 2004.
[10] Nayan B. Ruparelia. The history of version control. SIGSOFT Softw. Eng. Notes, 35(1):5-9, 2010.
[11] Bikram Sengupta, Satish Chandra, and Vibha Sinha. A research agenda for distributed software development. In ICSE '06: Proceedings of the 28th international conference on Software engineering, pages 731-740, New York, N.Y., USA, 2006. ACM.
[12] Michael S. V. Turner. Microsoft Solutions Framework Essentials. Microsoft Press, 2006.
[13] Jennifer Vesperman. Essential CVS. O'Reilly Media, 1st edition, 2003.

1. A method and software of concurrent development in distributed software projects:
1. creating a branch;
2. implementing a portion of functionality;
3. embedding puzzles into source code;
4. merging partially complete branch into trunk;
5. resolving puzzles in a new branch;
6. finishing the first branch.

2. The method and software according to claim 1, wherein the “concurrent development” is at least one of a concurrent development, a distributed development, a development.

3. The method and software according to claim 1, wherein the “distributed software project” is at least one of a distributed software project, a co-located software project, a software project, a project.

4. The method and software according to claim 1, wherein the “branch” is at least one of a version control branch, an isolated version of project artifact or artifacts, an copy of project documents or artifacts.

5. The method and software according to claim 1, wherein the “source code” is at least one of a source code, a document, a schema, a drawing, a file, a database.

6. The method and software according to claim 1, wherein the “puzzle” is at least one of a puzzle, a textual label, a mark, a source code commentary, a file, an electronic document.
